(19) United States
(12) Patent Application Publication
(10) Pub. No.: US 2020/0402514 A1
(43) Pub. Date: Dec. 24, 2020

(54) SPEECH CHIP AND ELECTRONIC DEVICE

(71) Applicant: BAIDU ONLINE NETWORK TECHNOLOGY (BEIJING) CO., LTD., Beijing (CN)

(72) Inventors: Xiaoping YAN, Beijing (CN); Chao TIAN, Beijing (CN)

(21) Appl. No.: 16/861,650

(22) Filed: Apr. 29, 2020

(30) Foreign Application Priority Data
Jun. 21, 2019 (CN) 201910544209.7

(51) Int. Cl. G10L 15/28; G10L 15/34; G06F 3/16

(52) U.S. Cl. CPC G10L 15/285; G06F 3/162; G10L 15/34

(57) ABSTRACT

The present disclosure proposes a speech chip and an electronic device. The speech chip includes: a peripheral interface connected to a speech receiver and configured to receive a speech signal; a bus matrix connected to the peripheral interface; a first processor connected to the bus matrix and configured to determine whether is the speech signal contains a wake-up word according to the speech signal; a second processor connected to the bus matrix and configured to perform signal denoising and speech recognition on the speech signal; and a memory array connected to the bus matrix.

### CROSS-REFERENCE TO RELATED APPLICATION

This application claims priority to and benefits of Chinese Patent Application Serial No. 201910544209.7, filed with the State Intellectual Property Office of P. R. China on Jun. 21, 2019, the entire content of which is incorporated herein by reference.

### FIELD

The present disclosure relates to the field of speech processing technologies, and more particularly, to a speech chip and an electronic device.

### BACKGROUND

At present, speech chips that perform functions of speech wake-up and speech signal processing usually adopt the following three types of architectures.

In the first type, a multi-core ARM (Advanced RISC Machine) architecture is adopted. For example, the A113X chip produced by Amlogic overall adopts a 64-bit architecture, 4-core ARM Cotex A53, and uses DDR4 (Data Direction Register 4) as an off-chip external storage device.

In the second type, a single-core DSP (Digital Signal Processor) architecture is adopted. For example, the ADADN8080 chip produced by ADI (Analog Devices, Inc.) uses a single-core DSP architecture with a single-chip L2 2 MB memory.

In the third type, a three-core DSP architecture is adopted. For example, the AK7707 chip produced by AKM (Asahi Kasei Microsystems, Inc.) adopts the 1×HIFI2 DSP+2×AKM DSP as the main system architecture and an on-chip storage.

### SUMMARY

The present disclosure provides a speech chip and an electronic device.

An embodiment of the present disclosure provides a speech chip, including:

a peripheral interface connected to a speech receiver and configured to receive a speech signal;

a bus matrix connected to the peripheral interface;

a first processor connected to the bus matrix and configured to determine whether the speech signal contains a wake-up word according to the speech signal;

a second processor connected to the bus matrix and configured to perform signal denoising and speech recognition on the speech signal; and

a memory array connected to the bus matrix.

An embodiment of the present disclosure provides an electronic device, including:

a microphone; and

a speech chip according to the embodiments of the first aspect of the present disclosure, the speech chip being connected to the microphone.

Additional aspects and advantages of embodiments of present disclosure will be given in part in the following descriptions, become apparent in part from the following descriptions, or be learned from the practice of the embodiments of the present disclosure.

### BRIEF DESCRIPTION OF THE DRAWINGS

These and other aspects and advantages of embodiments of the present disclosure will become apparent and more readily appreciated from the following descriptions made with reference to the accompanying drawings.

FIG. 1 is a schematic diagram of a speech chip according to embodiment 1 of the present disclosure.

FIG. 2 is a schematic diagram of a speech chip according to embodiment 2 of the present disclosure.

FIG. 3 is a schematic diagram of a speech chip according to embodiment 3 of the present disclosure.

FIG. 4 is a schematic diagram of an electronic device according to embodiment 4 of the present disclosure.

FIG. 5 is a block diagram of an exemplary electronic device applicable to implementing an embodiment of the present disclosure.

### DETAILED DESCRIPTION

Embodiments of the present disclosure are described below in detail, examples of the embodiments are shown in accompanying drawings, and reference signs that are the same or similar from beginning to end represent the same or similar components or components that have the same or similar functions. The embodiments described below with reference to the accompanying drawings are exemplary, are merely used to explain the present disclosure, and cannot be construed as a limit to the present disclosure.

Based on characteristics of speech wake-up and speech signal processing, such as processing after wake-up, differences between wake-up algorithms and processing algorithms, the present disclosure proposes a speech chip, which may improve quality of wake-up and speech signal recognition to achieve a higher recognition rate and better interaction experience, and may solve the technical problems of high costs and power consumption of the chip in the prior art.

The speech chip according to the embodiment of the present disclosure is connected to the speech receiver through the peripheral interface to receive the speech signal. And then, the first processor connected to the peripheral interface through the bus matrix obtains the speech signal, and determines whether the speech signal contains the wake-up word, and the second processor performs the signal denoising and the speech recognition on the speech signal, where the second processor is connected to the peripheral interface through the bus matrix. In the present disclosure, the first processor and the second processor can work in stages, so that when one processor of the two is in an operating state, the other processor can be controlled to be in a sleep state, thereby reducing power consumption of the speech chip by automatically adjusting the states of the first processor and the second processor, and freely saving power of the first processor and the second processor at different task stages for different power consumption modes, such as independent power down, frequency reduction and clock gating, etc. At the same time, compared with the speech chip in the prior art, chip design of the speech chip in the present disclosure is defined with software, and special customization is performed by selecting reasonable resources according to characteristics of existing speech algorithm, especially a size of the memory. At the same time, the speech chip in the present disclosure may remove conventional modules such as usb/pcie/mmc/nand flash, etc., and the minimum configuration may be adopted according to minimum requirements of the memory array to get rid of redundant designs without affecting the function and performance, so as to greatly reduce the area of the speech chip and save the overall costs of the speech chip.

The speech chip and the electronic device according to the embodiments of the present disclosure will be described with reference to the drawings.

FIG. 1 is a schematic diagram of a speech chip according to embodiment 1 of the present disclosure.

The speech chip according to the embodiment of the present disclosure may be applied to any electronic device, so that the electronic device performs functions such as speech wake-up, speech processing and speech recognition.

The electronic device may be a personal computer (PC), a cloud device, a mobile device, a smart speaker, etc. The mobile device may be, for example, a mobile device, a tablet computer, a personal digital assistant, a wearable device, a vehicle-mounted device, and other hardware devices having various operating systems, touch screens, and/or display screens.

As shown in FIG. 1, the speech chip 100 may include: a peripheral interface 10, a bus matrix 20, a first processor 31, a second processor 32, and a memory array 40. The peripheral interface 10 is connected to a speech receiver and configured to receive a speech signal. The bus matrix 20 is connected to the peripheral interface 10. The first processor 31 is connected to the bus matrix 20 and configured to determine whether the speech signal contains a wake-up word according to the speech signal. The second processor 32 is connected to the bus matrix 20 and configured to perform signal denoising and speech recognition on the speech signal. The memory array 40 is connected to the bus matrix 20.

In the embodiment of the present disclosure, the speech receiver is configured to collect or receive speech signals. For example, the speech receiver may be a microphone with a speech collection function, or an audio acceleration module, such as an external audio (AUDIO) module, which is not limited here.

The number of microphones may be one or more. For example, the microphone may be a microphone group, which is not limited in the present disclosure. For example, in order to improve the signal quality of the speech signal for the purpose of improving the accuracy of subsequent speech recognition, the microphone group may include two microphones, where one microphone may collect speech data input by a user and the other microphone may collect noise data. For example, one microphone may be disposed on the front of the electronic device for collecting the speech data input by the user. Those skilled in the art may understand that, in addition to normally collecting the speech data of the user, a small portion of environmental noise may also be collected. The other microphone may be disposed on the back of the electronic device for collecting the noise data. Those skilled in the art may understand that the noise data may also include a small portion of the speech data input by the user. The microphone group may subtract the noise data from the speech data and perform an amplification processing on the obtained data, so as to obtain the speech signal. Therefore, the collected speech signal is a speech signal obtained after denoising processing, which may improve the signal quality of the speech signal, so that the accuracy of the recognition result may be improved in subsequent speech recognition.

In the embodiment of the present disclosure, the speech chip 100 may adopt an independent structure of asynchronous and loosely coupled dual processors to complete wake-up and signal processing tasks separately. That is, the speech chip 100 includes two independent asynchronous dual-core processors, which are the first processor 31 and the second processor 32. The first processor 31 is configured to complete the wake-up task, and the second processor 32 is configured to complete the signal processing task.

It should be noted that, terms such as “first” and “second” are used herein for purposes of description and are not intended to indicate or imply relative importance or to implicitly indicate the number of technical features indicated. Thus, the feature defined with “first” and “second” may comprise or implicitly comprise at least one of the features.

That is, in the present disclosure, the speech chip 100 includes two processors, one of which is configured to complete the wake-up task and the other is configured to complete the signal processing task. In this manner, the two processors may work in stages, so that when one processor is in an operating state, the other processor can be controlled to be in a sleep state, thereby reducing the power consumption of the speech chip through automatically adjusting the states of the first processor 31 and the second processor 32, and freely saving power of the first processor 31 and the second processor 32 at different task stages for different power consumption modes, such as independent power down, frequency reduction and clock gating, etc.

For example, when the first processor 31 is in the operating state, the second processor 32 may be controlled to be in the sleep state, and when the second processor 32 is in the operating state, the first processor may be controlled to be in the sleep state. That is, in the present disclosure, the first processor 31 and the second processor 32 may be operated and controlled separately. Before the first processor 31 detects that the speech signal includes the wake-up word, the second processor 32 may not work, i.e., the second processor may be in the sleep state. When the first processor 31 detects that the speech signal contains the wake-up word, the second processor 32 may be started to perform the signal denoising and the speech recognition. When the second processor 32 is working, the first processor 31 may also enter the sleep state.

In an embodiment of the present disclosure, the first processor 31 may determine whether is the speech signal contains the wake-up word according to the speech signal. If yes, the first processor 31 may wake up the electronic device; otherwise, the first processor 31 does not wake up the electronic device. For example, when the electronic device is a smart speaker, it is determined that the speech signal contains the wake-up word when the speech signal input by the user includes “Xiaodu, Xiaodu”. And then, the smart speaker may be woken up. The wake-up word may be preset by a built-in program of the electronic device, or may be set by the user as needed to meet individual needs of the user, which is not limited in present disclosure.

When the first processor 31 determines that the speech signal contains the wake-up word, the second processor 32 may be started to perform the signal processing (such as amplification, denoising, echo cancellation, speech orientation recognition, etc.) and the speech recognition on the speech signal. In addition, after the second processor 32 is started, the first processor 31 may enter the sleep state to reduce the power consumption of the speech chip.

In an embodiment of the present disclosure, the memory array 40 is configured to store data of a wake-up model, operation data and system information. Compared with the speech chip in the prior art, the speech chip 100 according to the embodiment of the present disclosure may remove conventional modules such as usb/pcie/mmc/nand flash, etc., and adopt, according to minimum requirements of the memory array 40, the minimum configuration to get rid of redundant designs without affecting the function and performance, so as to greatly reduce the area of the speech chip and save the overall costs of the speech chip.

The speech chip according to the embodiment of the present disclosure is connected to the speech receiver through the peripheral interface to receive the speech signal. And then, the first processor connected to the peripheral interface through the bus matrix obtains the speech signal, and determines whether the speech signal contains the wake-up word, and the second processor performs the signal denoising and the speech recognition on the speech signal, where the second processor is connected to the peripheral interface through the bus matrix. In the present disclosure, the first processor and the second processor can work in stages, so that when one processor of the two is in an operating state, the other processor can be controlled to be in a sleep state, thereby reducing power consumption of the speech chip by automatically adjusting the states of the first processor and the second processor, and freely saving power of the first processor and the second processor at different task stages for different power consumption modes, such as independent power down, frequency reduction and clock gating, etc. At the same time, compared with the speech chip in the prior art, the speech chip in the present disclosure can remove conventional modules such as usb/pcie/mmc/nand flash, etc., thus the minimum configuration is adopted according to minimum requirements of the memory array to get rid of redundant designs without affecting the function and performance, so as to greatly reduce the area of the speech chip and save the overall costs of the speech chip.

As a possible implementation, considering the cost related factors, the memory array may use the lowest required static random-access memory (SRAM) to replace the high-power, high-cost DDR3/DDR4 storage external to the traditional speech chip. In detail, the memory array 40 may include: a system read-only memory (ROM), configured to store system information; a first SRAM, configured to store data of the wake-up model; and a second SRAM, configured to store operation data.

In the embodiment of the present disclosure, a size of the kernel memory of the speech chip 100, a size of the SRAM, and a size of the system memory may be set with software, that is, memory sizes of the memory array, the SRAM and the ROM may be customized. Consequently, the area of the speech chip may be minimized under the condition that the cost of the speech chip meets the requirements. For example, two SRAMs with 1.5 MB storage space may be defined with software as the first SRAM and the second SRAM, respectively.

The first SRAM and the second SRAM may be a splicing structure composed of multiple pieces, such that large-capacity storage may be realized.

As a possible implementation, for the difficulty in managing the power consumption of the first SRAM and the second SRAM, the first SRAM and the second SRAM may be divided into multiple SRAM cells, and the clock and power of each SRAM cell may be managed separately. For example, for a certain time period without data operation, local power off and clock gating may be performed on some SRAM cells to reduce invalid turnovers of clock data, and to achieve the purpose of flexible power consumption reduction.

In detail, both the first SRAM and the second SRAM have a plurality of SRAM cells, and the memory array 40 further includes: a processor configured to perform clock control and power control on each of the plurality of SRAM cells. When the first processor 31 operates, corresponding SRAM cells of the first SRAM are controlled to work and other SRAM cells do not work, and when the second processor 32 operates, corresponding SRAM cells of the second SRAM are controlled to work and other SRAM cells do not work.

That is to say, in the present disclosure, in terms of power consumption, in order to achieve finer power management, the first SRAM and the second SRAM may be divided into smaller SRAM cells. For example, the first SRAM and the second SRAM may be divided into 16 small SRAM cells, respectively, to realize separate power and clock control. Each SRAM cell monitors corresponding data operations to flexibly implement the power management of the memory. When the first processor 31 is monitored to be at work, i.e., when a wake-up word detection is performed on the speech signal, corresponding SRAM cells in the first SRAM may be controlled to work, and the rest SRAM cells do not work. When the second processor 32 is monitored to be at work, corresponding SRAM cells in the second SRAM may be controlled to work, and the rest SRAM cells do not work. Thus, local power off and clock gating may be performed on the SRAM cells that are not at work, thereby reducing invalid turnovers of the clock data and the power consumption of the speech chip 100.

It should be noted that there is no physical difference between the first SRAM and the second SRAM. In detail, the number of cells included in each SRAM may be set with software.

As a possible implementation, the first SRAM and the second SRAM may include an exclusive region and a shared region. The exclusive region may be performed by the first processor 31 or the second processor 32 for storage, and the shared region may be performed by the first processor 31 and the second processor 32 for storage. The number of exclusive regions and shared regions, and the memory size thereof may be set with software.

For example, the first SRAM and the second SRAM may each include: a first exclusive region, a second exclusive region and a shared region.

The first exclusive region may be performed by the first processor 31 for storage. The second exclusive region may be performed by the second processor 32 for storage. The shared region may be performed by both the first processor 31 and the second processor 32 for storage.

For example, for the first SRAM or the second SRAM, a first exclusive region of 1.5 MB storage space may be defined with software, and the first processor 31 stores the data of the wake-up model in the first exclusive region. A second exclusive region of 1.5 MB storage space may be defined with software, and the second processor 32 stores the operation data in the second exclusive region. A shared region of 0.5 MB storage space may also be defined with software, and the shared region is shared by the first processor 31 and the second processor 32.

For another example, the first SRAM may include a first exclusive region and a first shared region, and the second SRAM may include a second exclusive region and a second shared region.

The first exclusive region is performed by the first processor 31 for storage, and the first shared region is performed by both the first processor 31 and the second processor 32 for storage. The second exclusive region is performed by the second processor 32 for storage, and the second shared region is also performed by both the first processor 31 and the second processor 32 for storage.

For example, for the first SRAM, the first exclusive region of 1.5 MB storage space may be defined with software, and the first processor 31 stores the data of the wake-up model in the first exclusive region. The first shared region of 0.5 MB storage space may be defined with software, and be shared by the first processor 31 and the second processor 32. For the second SRAM, the second exclusive region of 1.5 MB storage space may be defined with software, and the second processor 32 stores the operation data in the second exclusive region. The second shared region of 0.5 MB storage space may be defined with software, and be shared by the first processor 31 and the second processor 32.

As a possible implementation, the above exclusive regions, such as the first exclusive region and the second exclusive region, may have a cacheable region to improve storage speed.

As a possible implementation, the above shared regions may have an uncacheable region to avoid the cache coherence problem, to increase the read-only efficiency and the maximum batch read efficiency, and to improve an overall throughput. For example, the throughput may be tripled.

In the present disclosure, that the exclusive region has the cacheable region and the shared region has the uncacheable region may be configured with software.

As a possible implementation, the first processor 31 and the second processor 32 may be connected to the bus matrix 20 through an advanced extensible interface (AXI). The bus matrix 20 is connected to an advanced high-performance bus (AHB) through an AXI/AHB converter, and the bus matrix 20 is connected to an advanced peripheral bus (APB) through an AXI/APB converter. The APB bus is connected to a peripheral device.

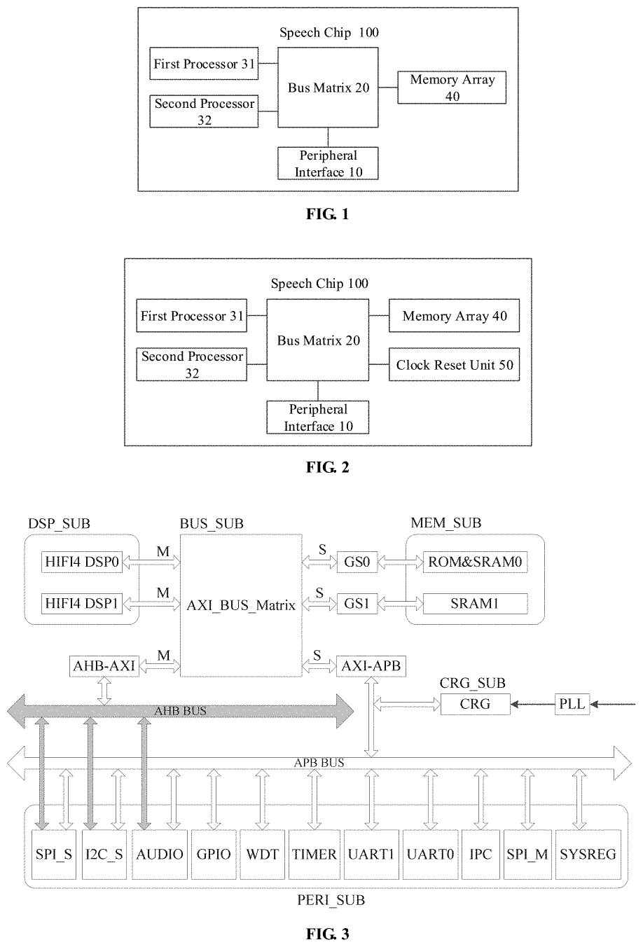

As a possible implementation, referring to FIG. 2, based on the embodiment illustrated in FIG. 1, the speech chip may further include a clock reset unit 50.

The clock reset unit 50 is connected to the bus matrix 20 and configured to control a clock and reset of the bus matrix 20, the first processor 31, the second processor 32 and the memory array 40. The clock reset unit 50 is connected to the bus matrix 20 through an AXI/APB converter.

In the embodiment of the present disclosure, the clock reset unit 50 is responsible for the clock and reset of all modules in the speech chip 100. Settings of clock frequency and duty cycle of each module may be flexibly set with software, and reset settings of each module may be independently configured in multiple levels. In addition, the clock reset unit 50 may also manage a clock frequency divider and clock gating of sub-modules in each module, such as the first SRAM and the second SRAM in the memory array 40, and the SRAM cells in the first SRAM and the second SRAM, and may set an appropriate working frequency for each module or each sub-module according to the needs with software, or directly close a clock input of each module as required. Therefore, the clock in each module or sub-module may be managed separately, thereby achieving the purpose of flexibly reducing the power consumption.

For example, the first processor 31 and the second processor 32 are digital signal processors (DSPs). Operations on external data of the DSP use a large cache line without a Prefetch structure design. The speech chip adopts an independent structure of asynchronous and loosely coupled dual HIFI4 DSP processors (HIFI4 DSP0 and HIFI4DSP1) to complete the wake-up and signal processing tasks separately. The speech chip realizes the main architecture by connecting to the bus matrix via a dual AXI bus mode, and by externally hooking up two independent large-capacity on-chip SRAMs and an audio interface design module (such as a peripheral AUDIO module in FIG. 3) is adopted to. Reference may be made to, for example, FIG. 3, which is a schematic diagram of a speech chip according to embodiment 3 of the present disclosure.

In FIG. 3, DSP_SUB is a DSP subsystem, including two independent asynchronous dual-core HIFI4 DSPs connected to the bus matrix through the AXI. Peripheral modules, the audio module, and a memory module are controlled through the bus matrix, and work is coordinated through a process controller, whose main task is to realize the wake-up and signal processing of the speech input, and whose main functions include wake-up, speech signal amplification, denoising, echo cancellation, remote positioning and other processing.

BUS_SUB is a bus subsystem, including bus bridge modules of AXI, AHB and APB, which are responsible for overall data transmission and work at different operating frequencies according to different bandwidth requirements. For example, settings of a frequency divider register may be configured with software to generate different required operating frequencies.

MEM_SUB is a memory subsystem, including a first SRAM (SRAM0) and a second SRAM (SRAM1), which are respectively configured to store the data of the wake-up model and operation storage data. In addition, the memory subsystem also includes a system ROM for storing system information. In view of the problem that power consumption of SRAMs is not easy to manage, each of SRAM0 and SRAM1 is divided into 16 SRAM cells, and the clock and power of each SRAM cell may be managed separately. In the present disclosure, SRAMs on the chip are reasonably divided and combined to freely implement an independent control of the power supply and clock gating, so that the module that consumes the most power may be finely controlled.

CRG_SUB is a clock reset group subsystem responsible for the clock and the reset of all modules. Settings of the clock frequency and duty cycle of each module may be flexibly set with software. Reset settings of each module may be independently configured into multiple levels. In the present disclosure, CRG_SUB may manage the clock divider and clock gating of all sub-modules as a whole, set the appropriate operating frequency for each module according to the needs with software, or directly close the clock input of each module as required.

PERI_SUB is a peripheral module subsystem supporting various external interfaces, such as uart/spi_slave/master/I2c_slve/i2S/pdm/tmd and other interfaces.

Therefore, the maximum operating frequency of the speech chip may be lower than 300M, and the maximum overall power consumption is lower than 250 milliwatts (mW). In addition, as the speech chip is a custom chip rather than a general-purpose chip, the conventional modules such as usb/pcie/mmc/nand flash may be removed, and the minimum configuration may be adopted according to minimum requirements of the algorithm memory to get rid of redundant designs without affecting the function and performance, so as to greatly reduce the area of the speech chip and save the overall costs of the speech chip. In this manner, the cost of a single speech chip is less than $1. In addition, the speech chip of the present disclosure may well perform a multi-channel input and parallel high-quality processing of the speech signal. The overall power consumption of the speech chip is lower than that of the speech chip in the prior art, thus the cost is greatly reduced. For users of smart speakers, the overall cost is a very important reference basis for purchase. For vehicle users, not only car-regulation-level requirements need to be met, power consumption indicators are also very important. Therefore, the speech chip of the present disclosure may meet demands of current smart speakers and automotive markets.

In order to implement the above embodiments, the present disclosure also proposes an electronic device.

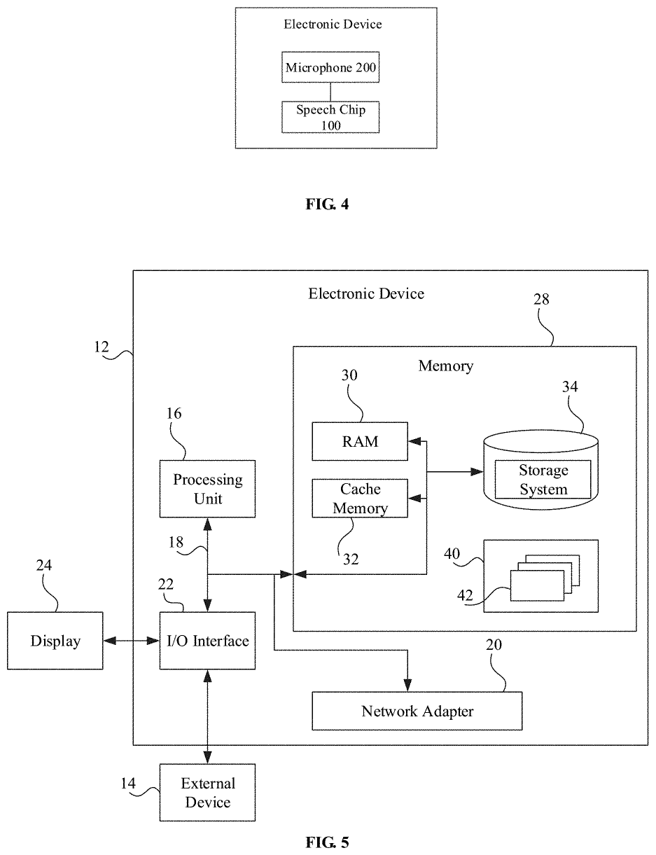

FIG. 4 is a schematic diagram of an electronic device according to embodiment 4 of the present disclosure.

The electronic device in the embodiment of the present disclosure may be a PC, a cloud device, a mobile device, a smart speaker, etc. The mobile device may be, for example, a mobile phone, a tablet computer, a personal digital assistant, a wearable device, a vehicle-mounted device, and other hardware devices having various operating systems, touch screens, and/or display screens.

As shown in FIG. 4, the electronic device may include a microphone 200 and the speech chip 100 provided in the foregoing embodiments of the present disclosure. The speech chip 100 is connected to the microphone 200.

In the embodiment of the present disclosure, the microphone 200 is configured to collect the speech signal. The number of the microphone 200 may be one or more. For example, the microphone 200 may be a microphone group, which is not limited in the present disclosure. For example, in order to improve the signal quality of the speech signal for the purpose of improving the accuracy of subsequent speech recognition, the microphone group may include two microphones, where one microphone may collect the speech data input by the user and the other microphone may collect noise data. As an example, one microphone may be disposed on the front of the electronic device for collecting the speech data input by the user. Those skilled in the art may understand that, in addition to normally collecting the speech data of the user, a small portion of environmental noise may also be collected. The other microphone may be disposed on the back of the electronic device for collecting the noise data. Those skilled in the art may understand that the noise data may also include a small portion of the speech data input by the user. The microphone group may subtract the noise data from the speech data and perform an amplification processing on the obtained data, so as to obtain the speech signal. Therefore, the collected speech signal is a speech signal obtained after denoising processing, which may improve the signal quality of the speech signal, so that the accuracy of the recognition result may be improved in subsequent speech recognition.

It should be noted that the foregoing explanation of the embodiments of the speech chip is also applicable to the electronic device according to this embodiment, and thus details will not be repeated herein.

FIG. 5 is a block diagram of an exemplary electronic device applicable to implementing implementations of the present disclosure. The electronic device 12 illustrated in FIG. 5 is only illustrated as an example, and should not be considered as any restriction on the function and the usage range of embodiments of the present disclosure.

As illustrated in FIG. 5, the electronic device 12 is in the form of a general-purpose computing apparatus. Components of the electronic device 12 may include, but is not limited to, one or more processors or processing units 16, a system memory 28, and a bus 18 connecting different system components (including the system memory 28 and the processing unit 16).

The bus 18 represents one or more of several types of bus architectures, including a memory bus or a memory controller, a peripheral bus, a graphic acceleration port (GAP), a processor, or a local bus using any bus architecture in a variety of bus architectures. For example, these architectures include, but are not limited to, an industry standard architecture (ISA) bus, a micro-channel architecture (MCA) bus, an enhanced ISA bus, a video electronics standards association (VESA) local bus, and a peripheral component interconnect (PCI) bus.

Typically, the electronic device 12 may include multiple kinds of computer-readable media. These media may be any storage media accessible by the electronic device 12, including transitory or non-transitory storage medium and removable or non-removable storage medium.

The memory 28 may include a computer-readable medium in a form of volatile memory, such as a random access memory (RAM) 30 and/or a high-speed cache memory 32. The electronic device 12 may further include other transitory/non-transitory storage media and removable/non-removable storage media. In way of example only, the storage system 34 may be used to read from and write to non-removable, non-volatile magnetic media (not shown in FIG. 5, commonly referred to as “hard disk drives”). Although not illustrated in FIG. 5, a disk driver for reading from and writing to removable non-volatile magnetic disks (e.g. “floppy disks”) may be provided, as well as an optical driver for reading from and writing to removable non-volatile optical disks (e.g. a compact disc read only memory (CD-ROM), a digital video disc read only Memory (DVD-ROM), or other optical media). In these cases, each driver may be connected to the bus 18 via one or more data medium interfaces. The memory 28 may include at least one program product, which has a set of (for example at least one) program modules configured to perform the functions of embodiments of the present disclosure.

A program/application 40 with a set of (at least one) program modules 42 may be stored in the memory 28, the program modules 42 may include, but not limit to, an operating system, one or more application programs, other program modules and program data, and any one or combination of above examples may include an implementation in a network environment. The program modules 42 are generally configured to implement functions and/or methods described in embodiments of the present disclosure.

The electronic device 12 may also communicate with one or more external devices 14 (e.g., a keyboard, a pointing device, a display 24, and etc.) and may also communicate with one or more devices that enable a user to interact with the electronic device 12, and/or may communicate with any device (e.g., a network card, a modem, and etc.) that enables the electronic device 12 to communicate with one or more other computing devices. This kind of communication can be achieved by an input/output (I/O) interface 22. In addition, the electronic device 12 may be connected to and communicate with one or more networks such as a local area network (LAN), a wide area network (WAN) and/or a public network such as the Internet through a network adapter 20. As shown in FIG. 5, the network adapter 20 communicates with other modules of the electronic device 12 over bus 18. It should be understood that although not shown in the FIG. 5, other hardware and/or software modules may be used in combination with the electronic device 12, which including, but not limited to, microcode, device drivers, redundant processing units, external disk drive arrays, RAID systems, tape drives, as well as data backup storage systems and the like.

The processing unit 16 can perform various functional applications and data processing by running programs stored in the system memory 28, for example, to perform functions such as speech wake-up, speech processing and speech recognition mentioned in embodiments of the present disclosure.

Reference throughout this specification to “an embodiment”, “some embodiments”, “an example”, “a specific example”, or “some examples” means that a particular feature, structure, material, or characteristic described in connection with the embodiment or example is included in at least one embodiment or example of the present disclosure. The appearances of the above phrases in various places throughout this specification are not necessarily referring to the same embodiment or example of the present disclosure. Furthermore, the particular features, structures, materials, or characteristics may be combined in any suitable manner in one or more embodiments or examples. In addition, different embodiments or examples and features of different embodiments or examples described in the specification may be combined by those skilled in the art without mutual contradiction.

In addition, in the description of the present disclosure, “a plurality of” means two or more than two, for example, two or three, etc., unless specified otherwise.

Any procedure or method described in the flow charts or described in other manners may herein may be understood to include one or more modules, portions or parts for executing instruction codes that implement the steps of specified logic function(s) or procedure. And preferable embodiments of the present disclosure include other implementation, in which the order of execution is different from that which is depicted or discussed, including executing functions in a substantially simultaneous manner or in an opposite order according to the related functions, which may be understood by the skilled in the art of embodiments of the present disclosure

The logic and/or step described in other manners herein or shown in the flow chart, for example, a particular sequence table of executable instructions for realizing the logical function, may be specifically achieved in any computer readable medium to be used by the instruction execution system, device or equipment (such as a system based on computers, a system comprising processors or other systems capable of obtaining the instruction from the instruction execution system, device and equipment and executing the instruction), or to be used in combination with the instruction execution system, device and equipment. As to the specification, “the computer readable medium” may be any device adaptive for including, storing, communicating, propagating or transferring programs to be used by or in combination with the instruction execution system, device or equipment. More specific examples (non-exhaustive list) of the computer readable medium comprise but are not limited to: an electronic connection (an electronic device) with one or more wires, a portable computer enclosure (a magnetic device), a random access memory (RAM), a read only memory (ROM), an erasable programmable read-only memory (EPROM or a flash memory), an optical fiber device and a portable compact disk read-only memory (CDROM). In addition, the computer readable medium may even be a paper or other appropriate medium capable of printing programs thereon, this is because, for example, the paper or other appropriate medium may be optically scanned and then edited, decrypted or processed with other appropriate methods when necessary to obtain the programs in an electric manner, and then the programs may be stored in the computer memories.

It should be understood that each part of the present disclosure may be realized by the hardware, software, firmware or their combination. In the above embodiments, a plurality of steps or methods may be realized by the software or firmware stored in the memory and executed by the appropriate instruction execution system. For example, if it is realized by the hardware, likewise in another embodiment, the steps or methods may be realized by one or a combination of the following techniques known in the art: a discrete logic circuit having a logic gate circuit for realizing a logic function of a data signal, an application-specific integrated circuit having an appropriate combination logic gate circuit, a programmable gate array (PGA), a field programmable gate array (FPGA), etc.

Those skilled in the art shall understand that all or parts of the steps in the above embodiments of the present disclosure may be achieved by commanding the related hardware with programs. The programs may be stored in a computer readable storage medium, and the programs comprise one or a combination of the steps in the method embodiments of the present disclosure when run on a computer.

In addition, respective function units of the embodiments of the present disclosure may be integrated in a processing module, and respective unit may further exist physically alone, and two or more units may be integrated in a processing module. The foregoing integrated module may be either in a form of hardware or in a form of software function modules. When the integrated module is realized as a form of software function module and is sold or used as a standalone product, the integrated module may be stored in a computer readable storage medium.

The storage medium mentioned above may be read-only memories, magnetic disks, CD, etc. Although embodiments of the present disclosure have been shown and described above, it should be understood that the above embodiments are exemplary, and it would be appreciated by the skilled in the art that the above embodiments cannot be construed to limit the present disclosure. The skilled in the art may make changes, alternatives, and modifications in the above embodiments without departing from scope of the present disclosure.

What is claimed is:

1. A speech chip, comprising:
a peripheral interface connected to a speech receiver and configured to receive a speech signal;
a bus matrix connected to the peripheral interface;
a first processor connected to the bus matrix and configured to determine whether the speech signal contains a wake-up word according to the speech signal;
a second processor connected to the bus matrix and configured to perform signal denoising and speech recognition on the speech signal; and
a memory array connected to the bus matrix.

2. The speech chip of claim 1, wherein
in response to determining that the speech signal contains the wake-up word, the first processor is configured to start the second processor to perform the signal denoising and speech recognition, and to enter a sleep state after the second processor is started.

3. The speech chip of claim 1, wherein the memory array comprises:
a system read-only memory (ROM), configured to store system information;
a first static random-access memory (SRAM), configured to store data of a wake-up model; and
a second SRAM, configured to store operation data.

4. The speech chip of claim 3, wherein both the first SRAM and the second SRAM have a plurality of SRAM cells, and the memory array further comprises:
a processor configured to perform clock control and power control on each of the plurality of SRAM cells, wherein when the first processor operates, corresponding SRAM cells of the first SRAM are controlled to work and other SRAM cells do not work, and when the second processor operates, corresponding SRAM cells of the second SRAM are controlled to work and other SRAM cells do not work.

5. The speech chip of claim 3, wherein each of the first SRAM and the second SRAM comprises:
a first exclusive region, configured to be performed by the first processor for storage;
a second exclusive region, configured to be performed by the second processor for storage; and
a shared region, configured to be performed by both the first processor and the second processor for storage.

6. The speech chip of claim 5, wherein both the first exclusive region and the second exclusive region have a cacheable region.

7. The speech chip of claim 5, wherein the shared region has an uncacheable region.

8. The speech chip of claim 1, wherein the first processor and the second processor are digital signal processors (DSPs).

9. The speech chip of claim 1, wherein the first processor and the second processor are connected to the bus matrix through an advanced extensible interface (AXI), the bus matrix is connected to an advanced high-performance bus (AHB) through an AXI/AHB converter, and the bus matrix is connected to an advanced peripheral bus (APB) through an AXI/APB converter, wherein the APB bus is connected to a peripheral device.

10. The speech chip of claim 1, further comprising:
a clock reset unit, connected to the bus matrix and configured to control a clock and reset of the bus matrix, the first processor, the second processor and the memory array, wherein the clock reset unit is connected to the bus matrix through an AXI/APB converter.

11. An electronic device, comprising:
a microphone; and
a speech chip connected to the microphone, the speech chip comprising:
a peripheral interface connected to the microphone and configured to receive a speech signal;
a bus matrix connected to the peripheral interface;
a first processor connected to the bus matrix and configured to determine whether the speech signal contains a wake-up word according to the speech signal;
a second processor connected to the bus matrix and configured to perform signal denoising and speech recognition on the speech signal; and
a memory array connected to the bus matrix.

12. The electronic device of claim 1, wherein
in response to determining that the speech signal contains the wake-up word, the first processor is configured to start the second processor to perform the signal denoising and speech recognition, and to enter a sleep state after the second processor is started.

13. The electronic device of claim 11, wherein the memory array comprises:
a system read-only memory (ROM), configured to store system information;
a first static random-access memory (SRAM), configured to store data of a wake-up model; and
a second SRAM, configured to store operation data.

14. The electronic device of claim 13, wherein both the first SRAM and the second SRAM have a plurality of SRAM cells, and the memory array further comprises:
a processor configured to perform clock control and power control on each of the plurality of SRAM cells, wherein when the first processor operates, corresponding SRAM cells of the first SRAM are controlled to work and other SRAM cells do not work, and when the second processor operates, corresponding SRAM cells of the second SRAM are controlled to work and other SRAM cells do not work.

15. The electronic device of claim 13, wherein each of the first SRAM and the second SRAM comprises:
a first exclusive region, configured to be performed by the first processor for storage;
a second exclusive region, configured to be performed by the second processor for storage; and
a shared region, configured to be performed by both the first processor and the second processor for storage.

16. The electronic device of claim 15, wherein both the first exclusive region and the second exclusive region have a cacheable region.

17. The electronic device of claim 15, wherein the shared region has an uncacheable region.

18. The electronic device of claim 11, wherein the first processor and the second processor are digital signal processors (DSPs).

19. The electronic device of claim 11, wherein the first processor and the second processor are connected to the bus matrix through an advanced extensible interface (AXI), the bus matrix is connected to an advanced high-performance bus (AHB) through an AXI/AHB converter, and the bus matrix is connected to an advanced peripheral bus (APB) through an AXI/APB converter, wherein the APB bus is connected to a peripheral device.

20. The electronic device of claim 11, further comprising:
a clock reset unit, connected to the bus matrix and configured to control a clock and reset of the bus matrix, the first processor, the second processor and the memory array, wherein the clock reset unit is connected to the bus matrix through an AXI/APB converter.
